(19) United States
(12) Patent Application Publication
(10) Pub. No.: US 2011/0151275 A1
(43) Pub. Date: Jun. 23, 2011

(54) Ultrasound-Assisted Friction Stir Welding

(76) Inventors: Gerd Dobmann, Saarbruecken (DE); Dietmar Eifler, Frankwiler (DE); Tobias Jene, Ottweiler (DE); Guntram Wagner, Otterberg (DE)

(21) Appl. No.: 12/921,254

(22) PCT Filed: Mar. 13, 2009
(86) PCT No.: PCT/EP2009/001847

§ 371 Date: Nov. 10, 2010

(30) Foreign Application Priority Data
Mar. 14, 2008 (DE) 10 2008 014 320.0

(51) Int. Cl. B32B 15/01; B23K 20/12; B23K 31/02

(52) U.S. Cl. 428/654; 428/544; 228/114

(57) ABSTRACT

A method for welding workpieces where at least two workpieces are welded together by means of friction stir welding, at least one of the workpieces being treated with ultrasound during the welding.

The invention relates to a friction stir welding process in which the formation of bands made of oxide particles along the weld seam is avoided. The invention relates in addition to a workpiece produced with this process.

Ultrasonic energy has been used in the most varied of fields since its discovery. Thus, further developments and also patent grants for selecting bulk materials are constantly taking place. Also ultrasound-assisted soldering has experienced increased attention in recent years and led to the applications for or granting of patents. It has also been known already since the middle of the last century that an ultrasonic treatment can lead to improvements in the weld seam quality in the case of fusion welding processes. For this purpose, melt is treated with ultrasound during solidification in order to influence the crystallisation processes advantageously. It is inherent to all these approaches that the treated material is situated either in a loose or liquid state.

In contrast hereto, it has to date always been assumed that a solid, not molten, material is not changed by treatment with ultrasound. For example, the solid body to be tested is not changed during an ultrasonic test.

The friction stir welding (FSW) process was developed in 1991 at the TWI (the Welding Institute), England and was able to be established since in the field of joining light metals. Friction stir welding is used already in ship-building and aviation and also in the manufacture of rail vehicles and road vehicles.

The process course of friction stir welding normally has the following steps: firstly, a rotating tool is pressed with high force between the workpieces at the contact point of the two workpieces until the tool shoulder comes to abut on the workpiece surface. The rotating tool then remains for a few seconds at the immersion point. Because of the friction between tool shoulder and the joint partners, the material heats below the shoulder to just below the melting point of the joint partners, however is not melted or liquefied. This temperature rise nevertheless results in a deterioration in strength, as a result of which the material is plasticised and mixing of the joint zone is achieved. Now the tool is moved along the joint zone with high contact pressure. A pressure gradient is produced between the front- and the rear-side of the tool. The rotational movement causes transport of plasticised material around the tool which is then mixed and forms the seam. At the end of the seam, the tool is withdrawn from the joint zone.

The surfaces of aluminium alloys are covered at room temperature by oxidation and passivation almost immediately (<<1 s) with a thin amorphous oxide layer and, in the further course, react with atmospheric oxygen up to an oxide layer thickness of approx. 10 nm. At high temperatures, as occur during hot-rolling of aluminium with large bars as pre-material which are preheated to 500 to 600° C., the oxide layer achieves a thickness of up to 100 μm (Sato, Y. S., et al. “Characteristics of the kissing-bond in friction stir welded Al alloy 1050”, Materials Science and Engineering A 405 (2005): 333-38; Sato, Y. S., et al. “FIB-assisted TEM study of an oxide array in the root of a friction stir welded aluminium alloy”, Scripta Materialia 50 (2003): 365-69).

By means of the friction stir welding process, these oxide adhesions are incorporated into the nugget of the weld joint. The oxide particles settle to form characteristic bands along the entire weld seam and can be detected clearly in cross-section as a line. Precisely with highly stressed, safety-relevant components, any type of irregularity in the weld seam represents however a potential site of danger.

The problem resulting herefrom for the seam has in the meantime received attention worldwide in the literature. The phenomenon is known inter alia as “Root Flaw” or “Nugget Flaw” and also “Line-type feature”, “Lazy-S” and “Zig Zag Line”. Recently also “Joint Line Remnant” has been used as a description of these oxide bands in the friction stir welding nugget.

Several studies testify that “Root Flaws” occur in all examined FSW seams and, with some aluminium alloys, cause a significant reduction in the tensile strength and resistance to cyclic deformation (fatigue) since the root flaws open within a few cycles.

The production of this irregularity can be avoided, according to the present state of the art only by mechanical removal of the surface oxides which is effected directly before the welding process (Okumara, H., et al. “Behaviour of oxides during friction stir welding of aluminium alloy and their effect on its mechanical properties”, Welding International 16.4 (2002): 266-75; Leonard, A. J. and S. A. Lockyer, “Flaws in Friction Stir Welds”, May 14, 2003 Park City, US: TWI, 2003. V 1-10; Jene, T., et al. “Monitoring of the Friction Stir Welding Process to Describe Parameter Effects on Joint Quality”, TWI, 2007). The mechanical removal implies not only increased time and machine expenditure. The process preparation also demands separate consideration in production planning, the result being more costs.

It is therefore the object of the present invention to indicate a friction stir welding process which avoids the occurrence of these oxide bands and enables substantially more fatigue-stable materials without requiring a cost-intensive operational preparation.

This object is achieved by the method according to claim 1, the welding device according to claim 12 and also the welded workpiece according to claim 14. The respective dependent claims indicate advantageous developments of the method, of the welding device and also of the welded workpiece.

In the case of conventional friction stir welding, the welding forces oscillate in the x, y and z directions. These forces can be measured with the help of a retrofittable dynamometer table. The oxide particles arrange themselves in a pattern corresponding to the ratio of feed per tool rotation (v_{f}).

The surprising knowledge underlying the invention is that the formation of an oxide band can be avoided if, during the welding, at least one of the workpieces is treated with ultrasound, although the material is not melted, during the friction stir welding, but instead remains a solid. The ultrasound is introduced thereby preferably in a region of the workpieces in which these are welded together.

It is surprising that the solid material, as is present in the friction stir welding course during the entire process, is influenced positively by the ultrasound.

The friction stir welding process has been known for over 18 years. However, although it is known with fusion welding processes, it has never been attempted to improve the quality of the friction stir welding seam by ultrasonic treatment since this procedure completely contradicts previous experiences with non-melted materials. The approach of superimposing the joining process with power ultrasound should therefore be regarded as completely new.

In addition, the original oxide lines which crucially influence in particular also the fatigue behaviour have only recently been able to be made visible at all in sections. The achieved improvement in microstructure in the solid state and hence the quasi-static and in particular cyclic behaviour of the friction stir welded joints by treatment with power ultrasound therefore represents, as mentioned already, a dramatically new approach with a considerable inventive step.

It is particularly suitable and therefore preferred if the ultrasound has a frequency of greater than or equal to 17 kHz, preferably greater than or equal to 30 kHz, preferably greater than or equal to 50 kHz. In addition, it is preferred if the ultrasound has a frequency of less than or equal to 120 kHz, preferably less than or equal to 100 kHz, preferably less than or equal to 80 kHz.

It has proved to be advantageous for the amplitude of the ultrasound if the latter is greater than or equal to 3 μm, preferably greater than or equal to 10 μm, preferably greater than or equal to 30 μm. Preferably, the amplitude is in addition less than or equal to 60 μm, preferably less than or equal to 50 μm, preferably less than or equal to 4 μm.

Various procedures are conceivable for introducing the ultrasound into the workpiece or workpieces. One possibility resides in introducing the ultrasound into the workpiece or workpieces by means of a sonotrode. The sonotrode is thereby applied on one of the workpieces, on both workpieces and/or the seam along which the welding takes place. It is possible to apply the sonotrode such that it oscillates perpendicular to the longitudinal direction of the seam and/or perpendicular to the surface of the workpieces to be welded. However, it can also be applied such that it oscillates parallel to the contact surface of the workpieces to be welded, i.e. in the longitudinal direction of the seam.

Alternatively or additionally, the welding tool itself can also introduce ultrasound into the workpiece or workpieces. The tool can hereby oscillate in the frequency of the ultrasound in a direction essentially or exactly perpendicular to the surface of the workpieces, perpendicular to the longitudinal direction of the weld seam and/or of the contact surface between the workpieces. However, the tool can also oscillate parallel to the surface and thereby perpendicular to the weld seam and/or parallel to the weld seam.

Preferably, the ultrasound is introduced parallel to the longitudinal direction of the weld seam or of the contact surface between the workpieces to be welded. It can be introduced such that it propagates parallel to the longitudinal direction of the weld seam and/or propagates in a plane of the surface on which the welding tool moves. The ultrasound can also propagate in the volume, i.e. in all spatial directions in the workpiece or workpieces.

The ultrasound can be introduced in addition perpendicular to the longitudinal direction of the weld seam of the friction stir welding. It can be introduced such that it propagates parallel to the longitudinal direction of the seam and/or propagates in one plane of the weld seam, i.e. in the plane defined by the abutting surfaces of the two workpieces to be joined. The ultrasound can in addition propagate in a direction perpendicular to this plane.

According to the invention, the ultrasound can be introduced as a longitudinal wave and/or as a transverse wave. As a longitudinal wave, it can propagate in the workpiece or workpieces, as described above. As transverse wave, it can in addition be introduced such that its amplitude is essentially perpendicular to that surface of the workpieces to be connected on which the welding tool runs along. In addition, with a transverse wave, the amplitude can be perpendicular to the surface of the weld seam, i.e. perpendicular to those surfaces of the workpieces with which the workpieces are welded together. In particular, the ultrasound can also propagate as shear wave in the workpiece or workpieces.

According to the invention, a welded workpiece is provided in addition, which is produced according to the above described method. This workpiece preferably has no oxide band along the weld seam. However, it has at least no oxide band along partial portions of the weld seam.

Since the method according to the invention is suitable in particular for light metal, in particular aluminium, the workpiece advantageously has a light metal, such as e.g. aluminium, or consists thereof.

Because of the ultrasound assistance, the friction stir welding process can be significantly improved. To date, oxide lines could only be avoided in the weld nugget by means of a cost-intensive operational preparation. This preparatory work can be dispensed with because of the proposed solution path. The ultrasound-assisted friction stir welding offers the possibility of welding untreated components without detectable oxide lines.

Via the direct advantage of avoiding oxide lines and the improvement resulting therefrom in mechanical properties, the ultrasound assistance also has a positive effect on the welding process in other aspects. Thus, the additional energy supply enables for example a higher welding speed.

Due to the integration of an internal or external oscillator system in the friction stir welding process, the method can be significantly improved. Via the active engagement in the process, the possibility exists in addition of using the introduced ultrasound at the same time for destruction-free testing and hence for examining the seam inline with respect to other irregularities, such as e.g. tubular pores. Such a non-destructive test is described for example in DE 198 10 509 C2.

In addition, a welding device for implementing the above-described method is according to the invention. This welding device therefore has at least one tool for implementing a friction stir welding. Furthermore, it has at least one device with which the workpiece or workpieces can be treated with ultrasound.

The invention is intended to be explained subsequently by way of example with reference to some Figures.

There are shown

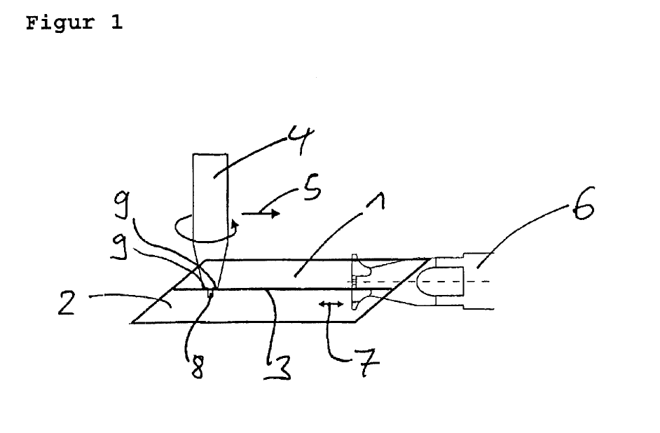

FIG. 1 a welding device according to the invention for implementing the method according to the invention,

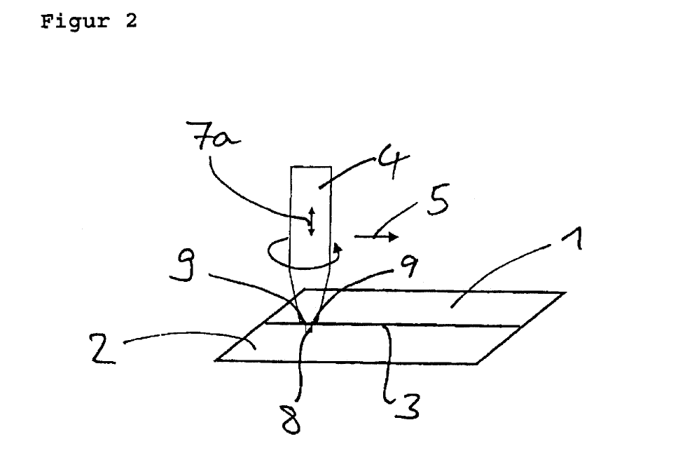

FIG. 2 a further welding device according to the invention for implementing the method according to the invention,

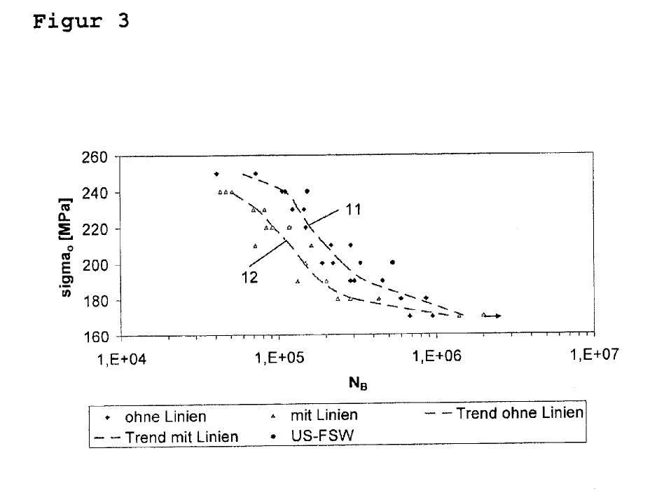

FIG. 3 a Wöhler stress line of AlMg₃Mn joints with R≈0.

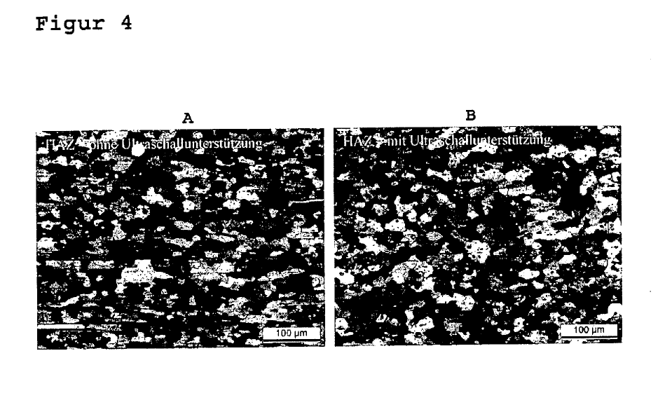

FIG. 4 cross-sections of the HAZ without (FIG. 4A) and with (FIG. 4B) ultrasound assistance, and

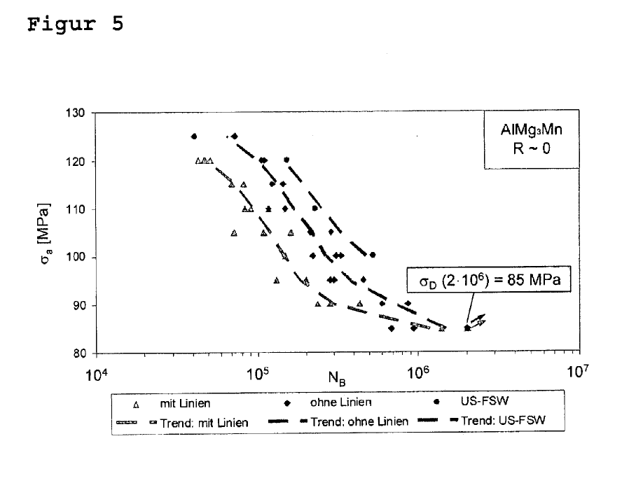

FIG. 5 a Wöhler stress line of a further AlMg₃Mn joint with R≈0.

FIG. 1 shows a device according to the invention for implementing the friction stir welding process according to the invention. Two workpieces 1 and 2 are hereby welded together along a weld seam 3. For this purpose, a rotating tool 4 for implementing the friction stir welding process is moved along the direction 5 towards a sonotrode 6 with which ultrasound can be supplied to the workpieces 1 and 2 to be connected. In the illustrated example, the ultrasound is introduced as a longitudinal wave with the oscillation direction 7. The ultrasound is therefore introduced in a direction parallel to the longitudinal direction of the weld seam 3. In the illustrated example, the tool 4 is perpendicular to the plane described by the surfaces of the workpieces 1 and 2. The tool 4 has a pin 8 with which it is pressed between the joint partners 1 and 2. The pin 8 is immersed into the weld seam 3 over its entire length so that the tool 4 is situated by the shoulders 9 on the surface of the workpieces 1 and 2 to be joined.

FIG. 2 shows a further embodiment of a tool according to the invention for implementing the method according to the invention. The same reference numbers here describe corresponding components as in FIG. 1. In the example shown in FIG. 2, the ultrasound is introduced by an oscillation of the tool 4 into the joint partners 1 and 2. For this purpose, the tool 4 oscillates along the direction 7a, i.e. in the direction of its longitudinal direction. The ultrasound is therefore introduced with an amplitude perpendicular to the surface of the workpieces 1 and 2 to be joined and perpendicular to the longitudinal direction of the weld seam 3. Longitudinal waves can hereby propagate in the interior of the workpiece. In addition, transverse waves can propagate on the surface of the workpieces 1 and 2 to be joined. In turn, the tool is guided along the direction 5 in the weld seam 3.

FIG. 3 shows a Wöhler diagram of an AlMg₃Mn joint with R=0 (average stress applied), in which ultrasound with a frequency of 20 kHz and an amplitude of 40 μm has been introduced in the x, y and z direction.

R thereby represents the stress ratio of low stress to high stress. A value of R=0 accordingly implies that the operation is taking place with a low stress of zero; a stress amplitude of 100 MPa with R=0 implies that the average stress is 100 MPa and the high stress is 200 MPa.

The curve 11 is hereby the Wöhler line for a weld seam without oxide bands and line 12 for a weld seam with oxide bands. The broken lines hereby indicate the trend, whilst the points show the measurement results. Sigma₀ hereby indicates the nominal stress amplitude, whilst N_{B} is the number of cycles at which the weld seam fails. It can be clearly detected that, with samples without detectable oxide bands 11 in comparison with conventionally friction stir welded samples 12 with oxide lines, the numbers of breaking stress cycles (number of cycles until breakage) are higher by approx. 50%. The joints without oxide lines were produced by a previous removal of the oxides. The method according to the invention hence leads to significantly more durable joints than friction stir welding processes according to the state of the art.

The two round dots to the extreme right at 200 and 240 MPa were produced with the method according to the invention. The fine distribution of the deposits hereby plays an important role in addition for avoiding detectable oxide lines without previous removal of the oxide skin. In the tests shown here, numbers of cycles to failure which are 3 times or 3.5 times higher than those of FSW seams with oxide lines were achieved.

A quantitative particle size analysis between friction stir welded seams welded conventionally and with ultrasound assistance in fact produced significant differences neither in the heat affected zone (HAZ) nor in the centre of the seam, the nugget.

However, a finer distribution of the deposits in the material results due to the ultrasound assistance. In FIGS. 4A and 4B, these deposits are visible as dark regions. Whilst in the photograph of the HAZ of the conventionally welded seam (FIG. 4A) few large deposits can be detected, the result is a substantially finer distribution due to the ultrasound assistance (FIG. 4B). This fine distribution of the deposits has a significantly positive effect on the fatigue strength.

The crucial advantage of using power ultrasound on FSW joints is represented again in FIG. 5. For measurement of these in FIG. 5, ultrasound with a frequency of 20 kHz and an amplitude of 40 μm was used also. It can be detected immediately that the treatment with power ultrasound leads to a significant improvement of the fatigue properties of the produced friction stir welded joint, characterised by a displacement of the curves to higher numbers of breaking stress cycles N_{B}.

The left curve (triangles) documents the fatigue behaviour of friction stir welded Al samples which reveal oxide lines in the sectional image, the middle curve (diamonds) shows the fatigue behaviour of Al samples without oxide lines after friction stir welding. Relative to the left curve, an increase in fatigue behaviour is produced if no oxide lines are present. The right curve (circles) shows the success of an additional ultrasonic treatment of a sample, such as the sample of the curve in the middle.

The number of breaking stress cycles N_{B}, e.g. with a load of 110 MPa therefore increases from 10⁵ for the sample with oxide lines via 1×10⁵ for the middle curve to 2×10⁵ for the ultrasound-treated friction stir welded sample. This corresponds to an increase in serviceable life by the factor 2 because of the ultrasonic treatment.

1-16. (canceled)

17. A method for welding workpieces which one of have and consist of a light metal, comprising:
welding at least two workpieces together using a friction stir welding, surfaces of the workpieces with which the workpieces are welded abutting against each other,
wherein at least one of the workpieces is treated with an ultrasound during the welding step.

18. The method according to claim 17, wherein the workpieces are treated with ultrasound in at least one region in which they are welded.

19. The method according to claim 17, wherein the ultrasound treatment takes place with ultrasound of a frequency of greater than or equal to 17 kHz.

20. The method according to claim 17, wherein the ultrasound treatment takes place with ultrasound of a frequency of greater than or equal to 30 kHz.

21. The method according to claim 17, wherein the ultrasound treatment takes place with ultrasound of a frequency of greater than or equal to 50 kHz.

22. The method according to claim 17, wherein the ultrasound treatment takes place with ultrasound of a frequency of less than or equal to 120 kHz.

23. The method according to claim 17, wherein the ultrasound treatment takes place with ultrasound of a frequency of less than or equal to 100 kHz.

24. The method according to claim 17, wherein the ultrasound treatment takes place with ultrasound of a frequency of less than or equal to 80 kHz.

25. The method according to claim 17, wherein the ultrasound treatment takes place with ultrasound with an amplitude of greater than or equal to 3 μm.

26. The method according to claim 17, wherein the ultrasound treatment takes place with ultrasound with an amplitude of greater than or equal to 10 μm.

27. The method according to claim 17, wherein the ultrasound treatment takes place with ultrasound with an amplitude of greater than or equal to 30 μm.

28. The method according to claim 17, wherein the ultrasound treatment takes place with ultrasound with an amplitude of less than or equal to 60 μm.

29. The method according to claim 17, wherein the ultrasound treatment takes place with ultrasound with an amplitude of less than or equal to 50 p.m.

30. The method according to claim 17, wherein the ultrasound treatment takes place with ultrasound with an amplitude of less than or equal to 40 μm.

31. The method according to claim 17, wherein the ultrasound is introduced using at least one sonotrode.

32. The method according to claim 17, wherein the ultrasound is introduced such that at least one of (a) the ultrasound is parallel to a longitudinal direction of a weld seam of the friction stir welding; (b) the ultrasound propagates parallel to the longitudinal direction of the weld seam; (c) the ultrasound propagates in one plane of the surface of at least one of the workpieces; and (d) the ultrasound propagates in the volume of at least one of the workpieces.

33. The method according to claim 17, wherein the ultrasound is introduced such that at least one of (a) the ultrasound is perpendicular to a longitudinal direction of a weld seam of the friction stir welding; (b) the ultrasound propagates parallel to the longitudinal direction of the weld seam; (c) the ultrasound propagates in one plane of the weld seam; and (d) the ultrasound propagates perpendicular to one plane of the weld seam.

34. The method according to claim 17, wherein the ultrasound is introduced as at least one of a longitudinal wave and a transverse wave.

35. The method according to claim 17, wherein the ultrasound is introduced via a tool effecting the friction stir welding.

36. A welded workpiece, comprising:
a light metal, the workpiece being produced by welding at least two workpieces together using a friction stir welding, surfaces of the workpieces with which the workpieces are welded abutting against each other,
wherein at least one of the workpieces is treated with an ultrasound during the welding.

37. The workpiece of claim 36, wherein the workpiece has no oxide band along a weld seam.

38. The workpiece of claim 36, wherein the light metal is aluminum.
